(19) United States
(12) Patent Application Publication
(10) Pub. No.: US 2007/0080887 A1
(43) Pub. Date: Apr. 12, 2007

(54) KA LNB umbrella shade

(76) Inventor: Kesse Ho, Westminster, CA (US)

Correspondence Address: THE DIRECTV GROUP INC, PATENT DOCKET ADMINISTRATION RE/R11/A109, P O BOX 956, EL SEGUNDO, CA, 90245-0956, US

(21) Appl. No.: 11/546,885

(22) Filed: Oct. 12, 2006

Related U.S. Application Data
(60) Provisional application No. 60/725,781, filed on Oct. 12, 2005.
(60) Provisional application No. 60/725,782, filed on Oct. 12, 2005.
(60) Provisional application No. 60/726,118, filed on Oct. 12, 2005.
(60) Provisional application No. 60/726,149, filed on Oct. 12, 2005.
(60) Provisional application No. 60/726,150, filed on Oct. 12, 2005.
(60) Provisional application No. 60/726,151, filed on Oct. 12, 2005.
(60) Provisional application No. 60/727,143, filed on Oct. 14, 2005.
(60) Provisional application No. 60/728,338, filed on Oct. 20, 2005.
(60) Provisional application No. 60/754,737, filed on Dec. 28, 2005.
(60) Provisional application No. 60/758,762, filed on Jan. 13, 2006.
(60) Provisional application No. 60/726,337, filed on Oct. 12, 2005.

(51) Int. Cl. H01Q 19/12

(52) U.S. Cl. 343/840; 343/784

(57) ABSTRACT

A system for receiving satellite signals from a satellite data delivery system is disclosed. A system in accordance with the present invention comprises a reflector, at least one Low Noise Block Amplifier (LNB), coupled to the reflector such that the reflector reflects the satellite signals toward the at least one LNB, a cover, coupled to the LNB, where the cover is transmissive to the satellite signals, and a shade, coupled to the LNB, wherein the shade protects the cover from incident rainfall.

### CROSS-REFERENCE TO RELATED APPLICATIONS

This application claims the benefit under 35 U.S.C. § 119(e) of the following and commonly-assigned U.S. provisional patent applications:

Application Ser. No. 60/725,781, filed on Oct. 12, 2005 by John L. Norin and Kesse Ho, entitled “TRIPLE STACK COMBINING APPROACH TO Ka/Ku SIGNAL DISTRIBUTION,” attorneys' docket number PD-205054;

Application Ser. No. 60/725,782, filed on Oct. 12, 2005 by Kesse Ho and John L. Norin, entitled “SINGLE LOCAL OSCILLATOR SHARING IN MULTI-BAND KA-BAND LNBS,” attorneys' docket number PD-205055;

Application Ser. No. 60/726,118, filed on Oct. 12, 2005 by John L. Norin, entitled “KA/KU ANTENNA ALIGNMENT,” attorneys' docket number PD-205058;

Application Ser. No. 60/726,149, filed on Oct. 12, 2005 by Kesse Ho, entitled “DYNAMIC CURRENT SHARING IN KA/KU LNB DESIGN,” attorneys' docket number PD-205059;

Application Ser. No. 60/726,150, filed on Oct. 12, 2005 by Kesse Ho, entitled “KA LNB UMBRELLA SHADE,” attorneys' docket number PD-205060;

Application Ser. No. 60/726,151, filed on Oct. 12, 2005 by John L. Norin and Kesse Ho, entitled “BAND UPCONVERTER APPROACH TO KA/KU SIGNAL DISTRIBUTION,” attorneys' docket number PD-205056;

Application Ser. No. 60/727,143, filed on Oct. 14, 2005 by John L. Norin and Kesse Ho, entitled “BAND UPCONVERTER APPROACH TO KA/KU SIGNAL DISTRIBUTION,” attorneys' docket number PD-205064;

Application Ser. No. 60/728,338, filed on October 12, 2005 by John L. Norin, Kesse Ho, Mike A. Frye, and Gustave Stroes, entitled “NOVEL ALIGNMENT METHOD FOR MULTI-SATELLITE CONSUMER RECEIVE ANTENNAS,” attorneys' docket number PD-205057;

Application Ser. No. 60/754,737, filed on Dec. 28, 2005 by John L. Norin, entitled “KA/KU ANTENNA ALIGNMENT,” attorneys' docket number PD-205058R;

Application Ser. No. 60/758,762, filed on Jan. 13, 2006 by Kesse Ho, entitled “KA LNB UMBRELLA SHADE,” attorneys' docket number PD-205060R; and

Application Ser. No. 60/726,337, filed Oct. 12, 2005, entitled “ENHANCED BACK ASSEMBLY FOR KA/KU ODU,” by Michael A. Frye et al., attorneys' docket number PD-205029, all of which applications are incorporated by reference herein.

### BACKGROUND OF THE INVENTION

1. Field of the Invention

The present invention relates generally to a satellite receiver system, and in particular, to a receive antenna assembly for such a satellite receiver system.

2. Description of the Related Art

Satellite broadcasting of communications signals has become commonplace. Satellite distribution of commercial signals for use in television programming currently utilizes multiple feedhorns on a single Outdoor Unit (ODU) which supply signals to up to eight IRDs on separate cables from a multiswitch.

FIG. 1 illustrates a typical satellite television installation of the related art.

System 100 uses signals sent from Satellite A (SatA) 102, Satellite B (SatB) 104, and Satellite C (SatC) 106 (with transponders 28, 30, and 32 converted to transponders 8, 10, and 12, respectively), that are directly broadcast to an Outdoor Unit (ODU) 108 that is typically attached to the outside of a house 110. ODU 108 receives these signals and sends the received signals to IRD 112, which decodes the signals and separates the signals into viewer channels, which are then passed to television 114 for viewing by a user. There can be more than one satellite transmitting from each orbital location.

Satellite uplink signals 116 are transmitted by one or more uplink facilities 118 to the satellites 102-106 that are typically in geosynchronous orbit. Satellites 102-106 amplify and rebroadcast the uplink signals 116, through transponders located on the satellite, as downlink signals 120. Depending on the satellite 102-106 antenna pattern, the downlink signals 120 are directed towards geographic areas for reception by the ODU 108.

Each satellite 102-106 broadcasts downlink signals 120 in typically thirty-two (32) different sets of frequencies, often referred to as transponders, which are licensed to various users for broadcasting of programming, which can be audio, video, or data signals, or any combination. These signals have typically been located in the Ku-band Fixed Satellite Service (FSS) and Broadcast Satellite Service (BSS) bands of frequencies in the 10-13 GHz range. Future satellites will likely also broadcast in a portion of the Ka-band with frequencies of 18-21 GHz

FIG. 2 illustrates a typical ODU of the related art.

ODU 108 typically uses reflector dish 122 and feedhorn assembly 124 to receive and direct downlink signals 120 onto feedhom assembly 124. Reflector dish 122 and feedhorn assembly 124 are typically mounted on bracket 126 and attached to a structure for stable mounting. Feedhorn assembly 124 typically comprises one or more Low Noise Block converters 128, which are connected via wires or coaxial cables to a multiswitch, which can be located within feedhorn assembly 124, elsewhere on the ODU 108, or within house 110. LNBs typically downconvert the FSS and/or BSS-band, Ku-band, and Ka-band downlink signals 120 into frequencies that are easily transmitted by wire or cable, which are typically in the L-band of frequencies, which typically ranges from 950 MHz to 2150 MHz. This downconversion makes it possible to distribute the signals within a home using standard coaxial cables.

The multiswitch enables system 100 to selectively switch the signals from SatA 102, SatB 104, and SatC 106, and deliver these signals via cables 124 to each of the IRDs 112A-D located within house 110. Typically, the multiswitch is a five-input, four-output (5×4) multiswitch, where two inputs to the multiswitch are from SatA 102, one input to the multiswitch is from SatB 104, and one input to the multiswitch is a combined input from SatB 104 and SatC 106. There can be other inputs for other purposes, e.g., off-air or other antenna inputs, without departing from the scope of the present invention. The multiswitch can be other sizes, such as a 6×8 multiswitch, if desired. SatB 104 typically delivers local programming to specified geographic areas, but can also deliver other programming as desired.

To maximize the available bandwidth in the Ku-band of downlink signals 120, each broadcast frequency is further divided into polarizations. Each LNB 128 can receive both orthogonal polarizations at the same time with parallel sets of electronics, so with the use of either an integrated or external multiswtich, downlink signals 120 can be selectively filtered out from travelling through the system 100 to each IRD 112A-D.

IRDs 112A-D currently use a one-way communications system to control the multiswitch. Each IRD 112A-D has a dedicated cable 124 connected directly to the multiswitch, and each IRD independently places a voltage and signal combination on the dedicated cable to program the multiswitch. For example, IRD 112A may wish to view a signal that is provided by SatA 102. To receive that signal, IRD 112A sends a voltage/tone signal on the dedicated cable back to the multiswitch, and the multiswitch delivers the satA 102 signal to IRD 12A on dedicated cable 124. IRD 112B independently controls the output port that IRD 112B is coupled to, and thus may deliver a different voltage/tone signal to the multiswitch. The voltage/tone signal typically comprises a 13 Volts DC (VDC) or 18 VDC signal, with or without a 22 kHz tone superimposed on the DC signal. 13 VDC without the 22 kHz tone would select one port, 13 VDC with the 22 kHz tone would select another port of the multiswitch, etc. There can also be a modulated tone, typically a 22 kHz tone, where the modulation schema can select one of any number of inputs based on the modulation scheme. For simplicity and cost savings, this control system has been used with the constraint of 4 cables coming for a single feedhom assembly 124, which therefore only requires the 4 possible state combinations of tone/no-tone and hi/low voltage.

To reduce the cost of the ODU 108, outputs of the LNBs 128 present in the ODU 108 can be combined, or “stacked,” depending on the ODU 108 design. The stacking of the LNB 128 outputs occurs after the LNB has received and downconverted the input signal. This allows for multiple polarizations, one from each satellite 102-106, to pass through each LNB 128. So one LNB 128 can, for example, receive the Left Hand Circular Polarization (LHCP) signals from SatC 102 and SatB 104, while another LNB receives the Right Hand Circular Polarization (RHCP) signals from SatB 104, which allows for fewer wires or cables between the feedhorn assembly 124 and the multiswitch.

The Ka-band of downlink signals 120 will be further divided into two bands, an upper band of frequencies called the “A” band and a lower band of frequencies called the “B” band. Once satellites are deployed within system 100 to broadcast these frequencies, the various LNBs 128 in the feedhorn assembly 124 can deliver the signals from the Ku-band, the A band Ka-band, and the B band Ka-band signals for a given polarization to the multiswitch. However, current IRD 112 and system 100 designs cannot tune across this entire resulting frequency band without the use of more than 4 cables, which limits the usefulness of this frequency combining feature.

By stacking the LNB 128 inputs as described above, each LNB 128 typically delivers transponders of information to the multiswitch, but some LNBs 128 can deliver more or less in blocks of various size. The multiswitch allows each output of the multiswitch to receive every LNB 128 signal (which is an input to the multiswitch) without filtering or modifying that information, which allows for each IRD 112 to receive more data. However, as mentioned above, current IRDs 112 cannot use the information in some of the proposed frequencies used for downlink signals 120, thus rendering useless the information transmitted in those downlink signals 120. Further, weather and other climate issues affect Ka-band signals more so than Ku-band signals.

It can be seen, then, that there is a need in the art for a system that can be expanded to include Ka-band downlink signals in expanded systems 100.

### SUMMARY OF THE INVENTION

To minimize the limitations in the prior art, and to minimize other limitations that will become apparent upon reading and understanding the present specification, the present invention discloses a system for receiving satellite signals from a satellite data delivery system. A system in accordance with the present invention comprises a reflector, at least one Low Noise Block Amplifier (LNB), coupled to the reflector such that the reflector reflects the satellite signals toward the at least one LNB, a cover, coupled to the LNB, where the cover is transmissive to the satellite signals, and a shade, coupled to the LNB, wherein the shade protects the cover from incident rainfall. The system further optionally includes the shade being coupled to the cover, the shade being made from a material that is transmissive to the satellite signals, and the satellite signals being at Ka-band frequencies.

Another system in accordance with the present invention comprises a plurality of satellites, wherein at least a first satellite in the plurality of satellites broadcasts a first set of satellite signals broadcast in a first frequency band, and at least a second satellite in the plurality of satellites broadcasts a second set of satellite signals in a second frequency band, and an antenna, comprising a reflector, a first Low Noise Block Amplifier (LNB) and a second LNB, coupled to the reflector such that the reflector reflects the first set of satellite signals toward the first LNB and the second set of satellite signals toward the second LNB, and a shade, coupled to the first LNB.

Such a system further optionally includes a cover, coupled to the first LNB, the cover being transmissive to the first set of satellite signals, the shade being coupled to the cover, the shade protecting the cover from incident rainfall, the shade being made from a material that is transmissive to the first set of satellite signals, and the first set of satellite signals being at Ka-band frequencies.

Other features and advantages are inherent in the system and method claimed and disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a typical satellite television installation of the related art;

FIG. 2 illustrates a typical ODU of the related art; and

FIGS. 3A-3B and FIG. 4 illustrate embodiments of umbrella shades of the present invention.

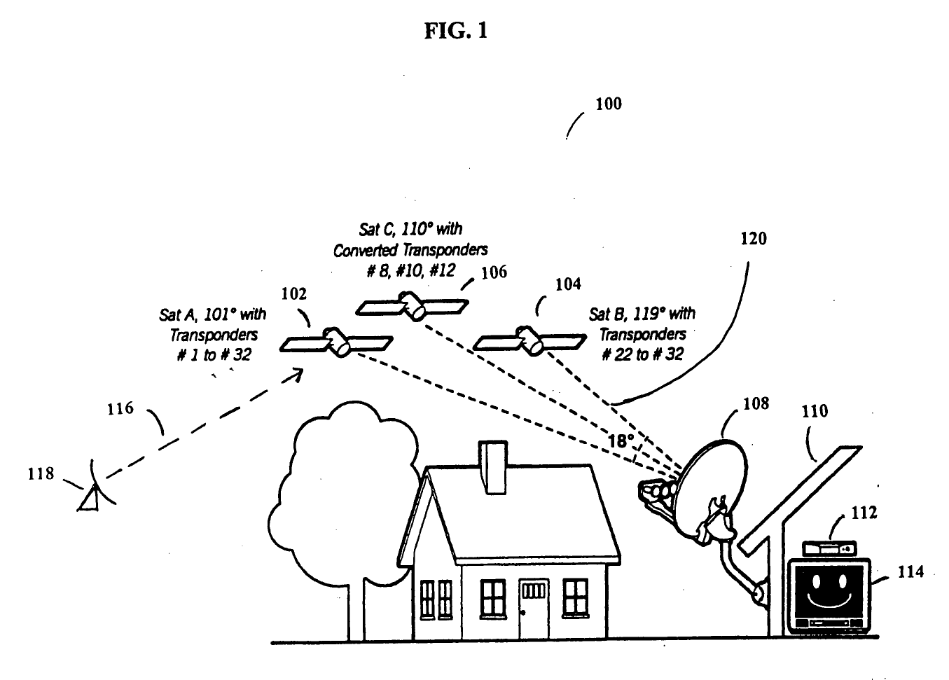

### DETAILED DESCRIPTION OF PREFERRED EMBODIMENTS

In the following description, reference is made to the accompanying drawings which form a part hereof, and which show, by way of illustration, several embodiments of the present invention. It is understood that other embodiments may be utilized and structural changes may be made without departing from the scope of the present invention.

Overview

Currently, there are three orbital slots, each comprising one or more satellites, delivering direct-broadcast television programming signals to the various ODUs 108. However, ground systems that currently receive these signals cannot accommodate additional satellite signals without adding more cables, and cannot process the additional signals that will be used to transmit the growing complement of high-definition television (HDTV) signals. The HDTV signals can be broadcast from the existing satellite constellation, or broadcast from the additional satellite(s) that will be placed in geosynchronous orbit. The orbital locations of the Ku-BSS satellites are fixed by regulation as being separated by nine degrees, so, for example, there is a satellite at 101 degrees West Longitude (WL), SatA 102; another satellite at 110 degrees WL, SatC 106; and another satellite at 119 degrees WL, SatB 104. Additional satellites may be at other orbital slots, e.g., 72.5 degrees, 95, degrees, 99 degrees, and 103 degrees, and other orbital slots, without departing from the scope of the present invention. The satellites are typically referred to by their orbital location, e.g., SatA 102, the satellite at 101 WL, is typically referred to as “101.” Additional orbital slots, with one or more satellites per slot, are presently contemplated at 99 and 103 (99.2 degrees West Longitude and 102.8 degrees West Longitude, respectively).

The present invention provides for additional protection of at least one of the LNBs 128 through the use of a shade or cover that reduces the amount of rain, dirt, or other potential interfering particles from the radome cover of the LNBs 128.

Umbrella Shades

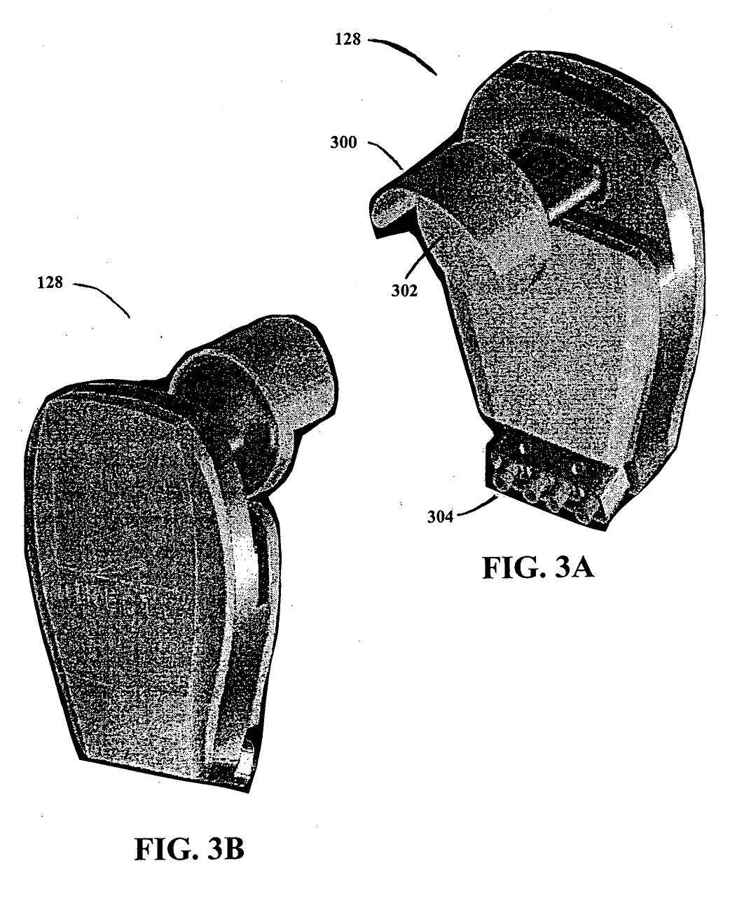

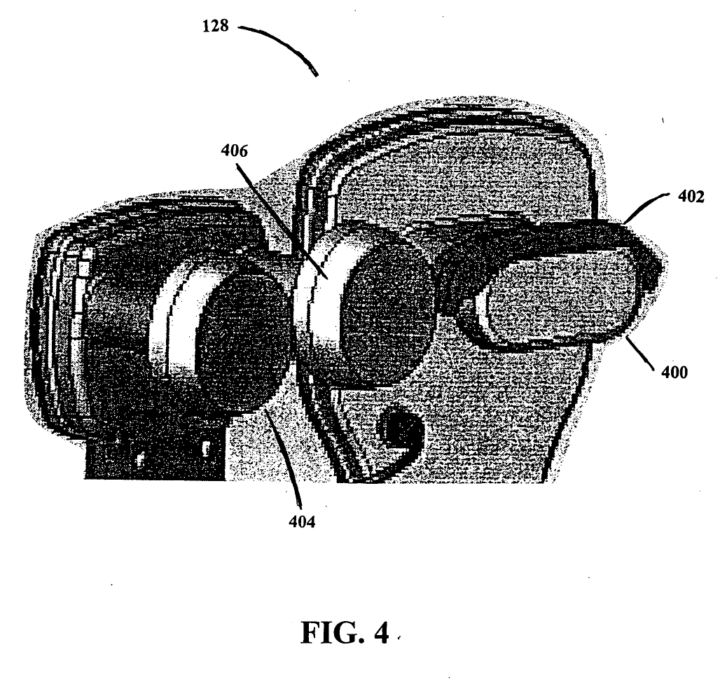

FIGS. 3A-3B and FIG. 4 illustrate embodiments of umbrella shades of the present invention.

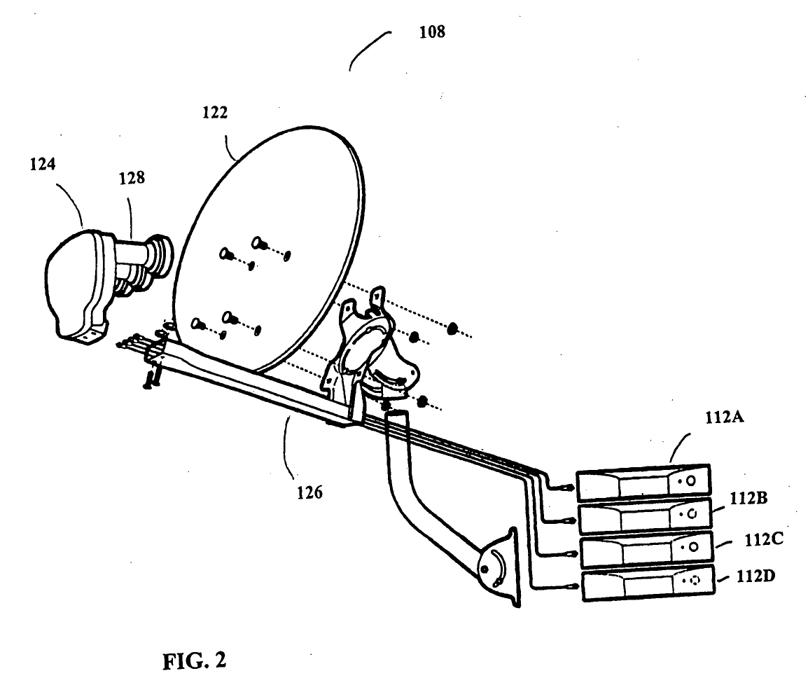

FIG. 3A illustrates a front perspective view of an LNB 128, with shade 300 attached on radome cover 302. Connectors 304 are also shown, which connect LNB 128 to IRD 112 via cables as shown in FIG. 2. FIG. 3B illustrates a rear perspective view of LNB 128 shown in FIG. 3A. Typically, shade 300 is made from the same material as radome cover 302, to allow for transmission through shade 300 if desired; however, shade 300 can be made from other materials, or attached elsewhere on LNB 128, without departing from the scope of the present invention.

Shade 300 protects radome cover 302 from rain and, possibly, other particulate matter, from accumulating on the front of radome cover 302. For radome covers 302 that are attached to a Ka-band feed, rain and/or particulate matter that is present on radome cover 302 provides scattering or attenuating material for the Ka-band downlink signals 120 that are reflected by reflector 122 and focused on LNB 128, specifically on the feedhorn that radome cover 122 protects. At Ka-band frequencies, water accumulation on radome cover 302 absorbs the incoming downlink signals 120, and, as such, the LNB 128 receives a lower power of downlink signal 120 than needed to properly process downlink signal for use by IRD 112 for presentation on monitor 114. Shade 300 reduces the amount of water and particulate matter that can accumulate on radome cover 302, and, as such, allows such downlink signals 120 to pass through with less scattering and/or attenuation.

For example, in a Ka-band of frequencies in the range of 18.3 GHz to 20.2 GHz, which is where downlink signals 120 typically reside, wetting of the radome cover 302 attenuates the Carrier-to-Noise (C/N) ratio of downlink signals 120 by as much as 2-3 dB, which reduces the downlink signals 120 to a power level below a useable level for the LNB 128. As such, shade 300 provides a method and apparatus for maintaining acceptable power levels for downlink signals 120.

Further, since LNB 128 is typically pointed downward (toward the ground) in southern regions of the United States, shade 300 provides almost complete coverage for radome cover 302, since shade 300 would overhang radome cover 302 at such an angle. Even for northern regions of the United States, where LNB 128 is pointed more horizontally, shade 300 provides ample coverage. Shade 300 may take on different shapes and/or configurations based on expected location of installation, or may be attached in an extendible way to radome cover 300, such that shade 300 can provide optimal coverage for radome cover 300 without interfering with reception of downlink signals 120.

FIG. 4 illustrates LNB 128, with radome cover 400 having shade 402, and radome covers 404 and 406. Radome cover 400, as shown in FIG. 4, can be of a shape that is more elliptical or oblong than other feedhorns 404-406. For example, radome cover 400 may cover two different LNB amplifier feeds, and thus making a single radome cover 400 with a shade 402 may be more cost-effective than a single radome cover 302 for each LNB 128 feedhorn. Further, radome covers 404 and 406 are shown without shade 402, because, at Ku-band frequencies, rain and particulate matter do not pose as significant of a scattering or attenuation problem as they do with Ka-band frequencies.

### CONCLUSION

In summary, the present invention comprises a system for receiving satellite signals from a satellite data delivery system. A system in accordance with the present invention comprises a reflector, at least one Low Noise Block Amplifier (LNB), coupled to the reflector such that the reflector reflects the satellite signals toward the at least one LNB, a cover, coupled to the LNB, where the cover is transmissive to the satellite signals, and a shade, coupled to the LNB, wherein the shade protects the cover from incident rainfall.

The system further optionally includes the shade being coupled to the cover, the shade being made from a material that is transmissive to the satellite signals, and the satellite signals being at Ka-band frequencies.

Another system in accordance with the present invention comprises a plurality of satellites, wherein at least a first satellite in the plurality of satellites broadcasts a first set of satellite signals broadcast in a first frequency band, and at least a second satellite in the plurality of satellites broadcasts a second set of satellite signals in a second frequency band, and an antenna, comprising a reflector, a first Low Noise Block Amplifier (LNB) and a second LNB, coupled to the reflector such that the reflector reflects the first set of satellite signals toward the first LNB and the second set of satellite signals toward the second LNB, and a shade, coupled to the first LNB.

Such a system further optionally includes a cover, coupled to the first LNB, the cover being transmissive to the first set of satellite signals, the shade being coupled to the cover, the shade protecting the cover from incident rainfall, the shade being made from a material that is transmissive to the first set of satellite signals, and the first set of satellite signals being at Ka-band frequencies.

It is intended that the scope of the invention be limited not by this detailed description, but rather by the claims appended hereto and the equivalents thereof. The above specification, examples and data provide a complete description of the manufacture and use of the composition of the invention. Since many embodiments of the invention can be made without departing from the spirit and scope of the invention, the invention resides in the claims hereinafter appended and the full range of equivalents thereof.

What is claimed is:

1. A system for receiving satellite signals from a satellite data delivery system, comprising:
a reflector;
at least one Low Noise Block Amplifier (LNB), coupled to the reflector such that the reflector reflects the satellite signals toward the at least one LNB;
a cover, coupled to the LNB, where the cover is transmissive to the satellite signals; and
a shade, coupled to the LNB, wherein the shade protects the cover from incident rainfall.

2. The system of claim 1, wherein the shade is coupled to the cover.

3. The system of claim 2, wherein the shade is made from a material that is transmissive to the satellite signals.

4. The system of claim 3, wherein the satellite signals are at Ka-band frequencies.

5. A system for delivering satellite signals to a receiver, comprising:
a plurality of satellites, wherein at least a first satellite in the plurality of satellites broadcasts a first set of satellite signals broadcast in a first frequency band, and at least a second satellite in the plurality of satellites broadcasts a second set of satellite signals in a second frequency band;
an antenna, comprising:
a reflector;
a first Low Noise Block Amplifier (LNB) and a second LNB, coupled to the reflector such that the reflector reflects the first set of satellite signals toward the first LNB and the second set of satellite signals toward the second LNB; and
a shade, coupled to the first LNB.

6. The system of claim 5, further comprising a cover, coupled to the first LNB.

7. The system of claim 6, wherein the cover is transmissive to the first set of satellite signals.

8. The system of claim 7, wherein the shade is coupled to the cover.

9. The system of claim 6, wherein the shade protects the cover from incident rainfall.

10. The system of claim 9, wherein the shade is made from a material that is transmissive to the first set of satellite signals.

11. The system of claim 10, wherein the first set of satellite signals are at Ka-band frequencies.
